(19) United States
(12) Patent Application Publication
(10) Pub. No.: US 2024/0403087 A1
(43) Pub. Date: Dec. 5, 2024

(54) SYSTEMS AND METHODS FOR CREATING AUTONOMOUS AGENTS FOR TESTING INTERACTIVE SOFTWARE APPLICATIONS

(71) Applicant: Microsoft Technology Licensing, LLC, Redmond, WA (US)

(72) Inventors: Christopher Ward DAVIS, Portland, OR (US); Logan Bruce JONES, Medford, OR (US); Andrea TREVIÑO GAVITO, Boston, MA (US); Haiyan ZHANG, Sammamish, WA (US); Yanjie HE, Rockyville, MD (US); Carleton Quarmon HALL, Lilburn, GA (US); Julia KAHNFELD, Zurich (CH)

(21) Appl. No.: 18/204,121

(22) Filed: May 31, 2023

(51) Int. Cl. G06F 9/455

(52) U.S. Cl. CPC G06F 9/455

(57) ABSTRACT

A system may obtain an emulator. A system may obtain a state detector. A system may receive one or more objective inputs at a large language model. A system may create a decision engine with the large language model and the objective inputs. A system may obtain at least one of video information, audio information, and software state data from the interactive software application at the state detector. A system may transmit state information from the state detector to the decision engine based at least partially on the at least one of video information, audio information, and software state data. A system may select an action with the decision engine in response to the state information. A system may transmit the action to the emulator. A system may transmit at least one emulated input of the action to the interactive software application.

### BACKGROUND

Creation of interactive software applications requires ongoing testing, revisions, and development. The testing can be incremental testing of different combinations of actions or settings, stress testing of the application on a variety of systems, or other tedious or time-consuming tasks. Improvements to the application testing can reduce development time and/or allow for greater refinement of a final product or service.

### BRIEF SUMMARY

In some aspects, the techniques described herein relate to a method of creating an autonomous agent for interacting with an interactive software application, the method including: obtaining an emulator; obtaining a state detector; receiving one or more objective inputs at a large language model; creating a decision engine with the large language model and the objective inputs; obtaining at least one of video information, audio information, and software state data from the interactive software application at the state detector; transmitting state information from the state detector to the decision engine based at least partially on the at least one of video information, audio information, and software state data; selecting an action with the decision engine in response to the state information; transmitting the action to the emulator; and transmitting at least one emulated input of the action to the interactive software application.

In some aspects, the techniques described herein relate to a system for interacting with an interactive software application, the system including: an agent computing device including: a decision engine configured to select an action in response to state information; a state detector that provides state information to the decision engine, wherein the state information is based at least partially on video information, audio information, and software state data from the interactive software application; and an emulator in communication with the decision engine, wherein the emulator generates emulated inputs in response to the action selected by the decision engine.

In some aspects, the techniques described herein relate to a method of interacting with an interactive software application instantiating an autonomous agent; obtaining at least one of video information, audio information, and software state data from the interactive software application at a state detector of the autonomous agent; transmitting state information from the state detector to a decision engine of the autonomous agent based at least partially on the at least one of video information, audio information, and software state data; selecting an action with the decision engine in response to the state information; transmitting the action to an emulator of the autonomous agent; and transmitting at least one emulated input of the action to the interactive software application.

This Summary is provided to introduce a selection of concepts in a simplified form that are further described below in the Detailed Description. This Summary is not intended to identify key features or essential features of the claimed subject matter. Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a diagram illustrating a system including an autonomous agent communicating with an interactive software application, according to at least some embodiments of the present disclosure.

FIG. 2 is a schematic illustration of a machine learning model including a neural network, such as a large language model, according to at least some embodiments of the present disclosure.

FIG. 3 is a decision engine including a fuzzy cognitive map, according to at least some embodiments of the present disclosure.

FIG. 4-1 is an example fuzzy cognitive map created to navigate through and interact with objects, non-player characters, and environmental elements in a three-dimensional virtual environment, according to at least some embodiments of the present disclosure.

FIG. 4-2 an example set of possible decisions of the fuzzy cognitive map of FIG. 4-1, according to at least some embodiments of the present disclosure.

FIG. 5 is a front view of an embodiment of a user input device emulated by an emulator, according to at least some embodiments of the present disclosure.

FIG. 6 is an illustration of a motion vector field, according to at least some embodiments of the present disclosure.

FIG. 7 is a frame of video information received from the interactive software application that may be used for identifying events within the user's gameplay, according to at least some embodiments of the present disclosure.

FIG. 8 is a flowchart illustrating a method of creating an autonomous agent for interacting with an interactive software application, according to at least some embodiments of the present disclosure.

FIG. 9 illustrates a system including an autonomous agent with a decision engine including a large language model, according to at least some embodiments of the present disclosure.

FIG. 10 is a flowchart illustrating a method of using an autonomous agent to interact with an interactive software application, according to at least some embodiments of the present disclosure.

FIG. 11 is a system including an autonomous agent with a fuzzy cognitive map library in the decision engine, according to at least some embodiments of the present disclosure.

### DETAILED DESCRIPTION

The present disclosure relates generally to the creation and operation of autonomous agents to interact with an interactive software application. More particularly, the present disclosure relates to the training, refinement, and communication of autonomous agents for interacting and testing an interactive software application. Interactive software application development requires extensive development cycles, where a common and time-consuming bottleneck to delivery is testing. In some embodiments, systems and methods, according to the present disclosure, allow a developer to build autonomous agents that can test interactive software applications in a workflow similar to a human to accurately replicate a user experience. In some embodiments, autonomous agents more accurately simulate human testing and can reduce the time to market for interactive software application development.

Conventional autonomous agent models using reinforcement learning and/or imitation learning models require large computational resources and/or large training datasets. The large computational resources needed for reinforcement learning models are expensive in time, electrical power, and money. For the testing of new interactive software applications, large training datasets are not available.

In some embodiments, an autonomous agent, according to the present disclosure, includes a decision engine created and/or trained linguistically by a large language model, and the autonomous agent interacts with the interactive software application via an emulated user input device. In some embodiments, the large language model is the decision engine. In some embodiments, a decision engine including a large language model can provide a wider variety of interpretations and decisions than a decision model created by and/or trained linguistically by the large language model. In some embodiments, a decision engine including a dedicated model, such as fuzzy cognitive map, created by and/or trained linguistically by a large language model is less computationally resource intensive and allows faster decisions made by the decision engine. In some embodiments, the agent includes a decision engine library that allows the agent to change, replace, select, or modify an active decision engine based at least partially on a user input and/or state information of the interactive software application. For example, different modes, settings, or operating conditions of the interactive software application may produce or allow different possible state information and different possible decisions. By changing, replacing, selecting, or modifying the active decision engine based at least partially on a user input and/or state information of the interactive software application, the decision engine can remain lightweight and tailored to the tasks, environment, and decisions currently present in the interactive software application.

In some embodiments, the autonomous agent determines state information about a state of the interactive software application through an object or event detection model. In some embodiments, the object or event detection model includes a machine vision model that detects objects and/or events in the interactive software application through a visual (and, optionally, audio) output of the interactive software application.

In some embodiments, the object or event detection model receives state data from the interactive software application independently of audiovisual information, such as via an application programming interface (API) of the interactive software application. The state data is used to determine the state of the interactive software application and provide the state to a fuzzy cognitive model of the autonomous agent. In some embodiments, the agent accesses or obtains an application module that identifies and interprets the state data as linguistic inputs to the fuzzy cognitive model. In at least one example, the application module allows the fuzzy cognitive model to interpret an object identification (ID) provided in the state data as a door, with which the agent may subsequently attempt to interact based at least partially on an action inventory.

In some examples, input to the autonomous agent (or component of the autonomous agent) and/or output from the autonomous agent (or component of the autonomous agent) is multimodal, which, as used herein, comprises one or more types of content. Example content includes, but is not limited to, spoken or written language (which may also be referred to herein as “natural language output”), code (which may also be referred to herein as “programmatic output”), images, video, audio, gestures, visual features, intonation, contour features, poses, styles, fonts, and/or transitions, among other examples. Thus, as compared to a machine learning model that processes natural language input and generates natural language output, aspects of the present disclosure may process input and generate output having any of a variety of content types.

In some embodiments, the agent receives one or more objective inputs from a user via a client device that provides the agent with an objective. In some embodiments, the objective inputs are provided to the large language model, and the large language model trains and/or creates a decision engine that selects actions from the action inventory to achieve an objective of the objective input(s). In some embodiments, the objective inputs are provided to the large language model, and the large language model selects actions from the action inventory to achieve an objective of the objective input(s).

By interpreting state information of the state of the interactive software application, selecting an action from an action inventory of available actions in the interactive software application, and providing inputs to the interactive software application through the emulator, which emulates a physical user input device, some embodiments of an autonomous agent, according to the present disclosure, interact with the interactive software application as a human does. In doing so, an autonomous agent, according to the present disclosure, provides a more accurate simulation of a human testing the interactive software application and a more accurate representation of a human user. In some embodiments, the autonomous agent interacts with and reacts to the interactive software application as a human does, without additional API calls or plugins. For example, from the perspective of the interactive software application, no changes are necessary for the autonomous agent to interpret the audio and/or video information generated by the interactive software application or for the autonomous agent to provide inputs to the interactive software application through an emulated input device.

In at least one embodiment, a system including an autonomous agent, according to the present disclosure, allows a user to provide an objective input(s) to a plurality of autonomous agents interacting with a plurality of copies of the interactive software, thereby allowing the user to conduct or oversee a plurality of concurrent tests of the interactive software application. Testing of the interactive software application is shortened, decreasing the development cycle of the interactive software application.

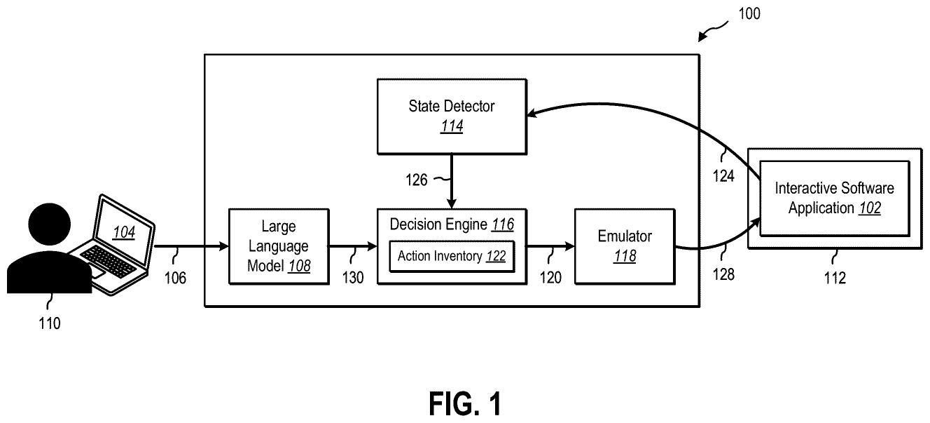

FIG. 1 is a diagram illustrating an embodiment of a system including an autonomous agent 100 communicating with an interactive software application 102. In some embodiments, a client device 104 provides objective inputs 106 to a large language model 108 of the autonomous agent 100. In some embodiments, a user 110 of the client device 104 provides the objective inputs 106. The autonomous agent 100 uses the objective inputs 106 to direct the decisions made by and emulated inputs provided by the autonomous agent 100 to the interactive software application 102.

In some embodiments, the interactive software application 102 is executed on an application computing device 112 that runs the interactive software application 102 remotely from the autonomous agent 100. In some embodiments, the application computing device 112 is a personal computing device, such as a laptop computer, a desktop computer, a hybrid computing device, a tablet computing device, a smartphone computing device, a video game console computing device, or other computing device. In some embodiments, the application computing device 112 is a server computing device that executes the interactive software application 102 remotely from the autonomous agent 100. In some embodiments, the application computing device 112 is a client device 104. For example, the application computing device 112 is a desktop computer client device 104, the user 110 interacts with the desktop computer client device 104, and the autonomous agent 100 runs remotely to the client device 104 and the application computing device 112. In at least one example, the application computing device 112 is a video game console, the client device 104 is a personal computing device, and the autonomous agent 100 is executed on a server computer (or plurality of server computers) with which the client device 104 and application computing device 112 communicate via network communications.

In some embodiments, the application computing device 112 executes the autonomous agent 100. For example, the application computing device 112 is a server computing device that runs both the interactive software application 102 and the autonomous agent 100. In another example, the application computing device 112 is a desktop computing device that runs both the interactive software application 102 and the autonomous agent 100. In some embodiments, the application computing device 112 executes at least one component of the autonomous agent 100. For example, the application computing device 112 executes at least one of a state detector 114, a decision engine 116, an emulator 118, or a large language model 108. In a particular example, a decision engine 116 transmits an action 120 selected from an action inventory 122 to an emulator 118 that runs natively on the application computing device 112. The emulator 118 then provides emulated inputs to the interactive software application 102.

In some embodiments, the state detector 114 is executed locally (e.g., on the same computing device) as the interactive software application 102. For example, a state detector 114 performs object and/or event detection on video information from the interactive software application 102 rendered on the application computing device 112 and provides the object and/or event detection information to the decision engine 116 being executed remotely (e.g., on a server computing device).

The interactive software application 102 is any category or genre of interactive software with which a user 110 and/or agent 100 interacts in real-time during usage of the interactive software application 102. In some embodiments, the interactive software application 102 is an electronic game. In some embodiments, the interactive software application 102 is design software, such as computer assisted design software. In some embodiments, the interactive software application 102 is office productivity software, such as a word processor. In some embodiments, the interactive software application 102 is an internet or network browser. In some embodiments, the interactive software application 102 is educational software.

In at least one example, the application computing device 112 and the client device 104 are the same device. In some embodiments, the application computing device 112, an agent computing device 101 (i.e., a computing device executing at least a portion of the autonomous agent 100), and the client device 104 are the same device. In some embodiments, the agent computing device and the client device 104 are the same device. In some embodiments, the agent computing device 101 and the application computing device 112 are the same device.

In some embodiments, the agent computing device 101 includes at least one processor and at least one hardware storage device in communication with the processor. The hardware storage device has instructions stored thereon that, when executed by the processor, cause the agent computing device 101 to execute at least some portions of any of the embodiment of methods described herein and/or execute at least some components of any embodiment of an autonomous agent 100 described herein.

As described herein, the autonomous agent 100 replicates a human user of the interactive software application 102 by use of components that replicate one or more of how a human user receives video and/or audio information 124 from the interactive software application 102, how a human user interprets state information 126 in the video and/or audio information 124, how a human user reacts to the objects and/or events toward an objective 130 (e.g., based at least partially on the objective input 106), how a human user selects an action 120 in response to the state information 126, and how a human user provides a user input device input (e.g., emulated input 128) to the interactive software application 102 to effect the action 120 in the interactive software application 102. By replicating a human user's interaction with the interactive software application 102, the autonomous agent 100, in some embodiments, allows for more accurate testing of the interactive software application 102 without direct invention from a human user and/or allows for more accurate simulation of a teammate, an opponent, or another user interacting with the interactive software application 102 in real-time with a human user.

In some embodiments, the components of the autonomous agent 100 use different types of machine learning models or other logic models to efficiently simulate a human user. The state detector 114 is or includes, in some embodiments, a machine vision neural network to identify virtual objects, textures, characters, animations, events, sounds, or other details of the video and/or audio information as will be described in more detail herein. The emulator 118 is or includes, in some embodiments, an imitation learning model, that allows the emulator to associate emulated inputs 128 with actions 120 as will be described in more detail herein.

The decision engine 116 is or includes, in some embodiments, a state machine (e.g., a heuristic-based state machine). In some embodiments, the decision engine is or includes a fuzzy cognitive map that receives the state information 126 from the state detector 114 and selects an action 120 from an action inventory 122 toward an objective 130, as will be described in more detail herein. In some embodiments, a large language model 108 receives objective input(s) 106 and trains or creates the decision engine 116 with an array of available actions and reactions that effectuate an objective 130 as will be described in more detail herein. In at least one embodiment, the large language model 108 is the decision engine 116, and the large language model 108 makes decisions toward effectuating the objective 130. In some embodiments, the decision engine 116 includes a plurality of fuzzy cognitive maps that allow the decision engine 116 to be customized based on the state information 126. In at least one example, each fuzzy cognitive map is lightweight and less computationally resource intensive than a large language model 108, allowing the decision engine 116 to react to the state information 126 and select an action 120 more quickly than a large language model 108. In some embodiments, a plurality of fuzzy cognitive maps allows the decision engine to limit decisions and action selection based on context from the state information, further reducing computational requirements and improving speed and efficiency.

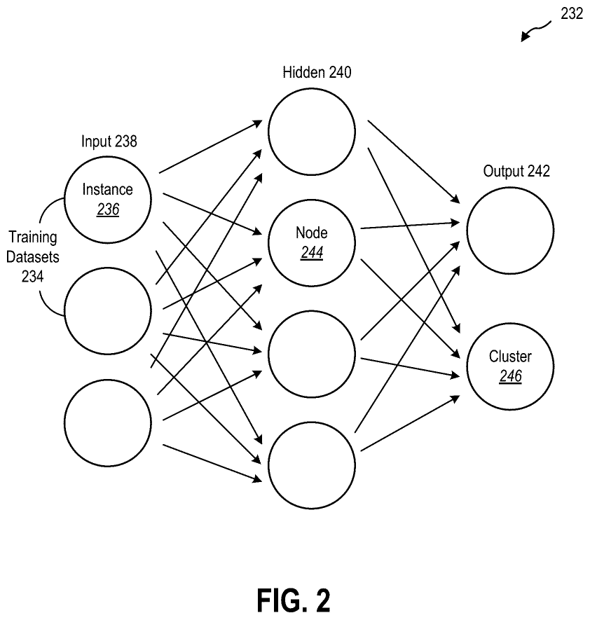

FIG. 2 is a schematic illustration of a machine learning model 232 including a neural network, such as a large language model. In some embodiments, the neural network has a plurality of layers with an input layer 238 configured to receive at least one input training dataset 234 or input training instance 236 and an output layer 242, with a plurality of additional or hidden layers 240 therebetween. The training datasets can be input into the neural network to train the neural network and identify individual and combinations of labels or attributes of the training instances. In some embodiments, the neural network can receive multiple training datasets concurrently and learn from the different training datasets simultaneously. While the illustrated embodiment includes a limited quantity of nodes, it should be understood that, in some embodiments, a large language model has millions, billions, or more of nodes 244 in the input layer 238, hidden layers 240, output layer 242, or combination thereof.

In some embodiments, the machine learning system includes a plurality of machine learning models that operate together. Each of the machine learning models has a plurality of hidden layers 240 between the input layer 238 and the output layer 242. The hidden layers 240 have a plurality of input nodes (e.g., nodes 244), where each of the nodes 244 operates on the received inputs from the previous layer. In a specific example, a first hidden layer 240 has a plurality of nodes and each of the nodes performs an operation on each instance from the input layer 238. Each node of the first hidden layer 240 provides a new input into each node of the second hidden layer, which, in turn, performs a new operation on each of those inputs. The nodes of the second hidden layer then passes outputs, such as identified clusters 246, to the output layer 242.

In some embodiments, each of the nodes 244 has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset. The values of the output layer, in some embodiments, are compared to known values of training instances, and parameters associated with each node of the hidden layer(s) allow back propagation through the neural network to refine and train the neural network.

In at least one example, a large language model including a machine learning model or neural network, according to the present disclosure, is trained on a corpus of training datasets including millions, billions, or more of training instances. The resulting large language model allows a user (such as user 110 of FIG. 1) to provide objective inputs 106 or other inputs to the large language model (such as the large language model 108 of FIG. 1) to explain how to interact with the interactive software application (such as the interactive software application 102 of FIG. 1). The large language model can, based at least partially on the inputs of the user, create a decision engine and/or operate as a decision engine (such as the decision engine 116 of FIG. 1) of an autonomous agent.

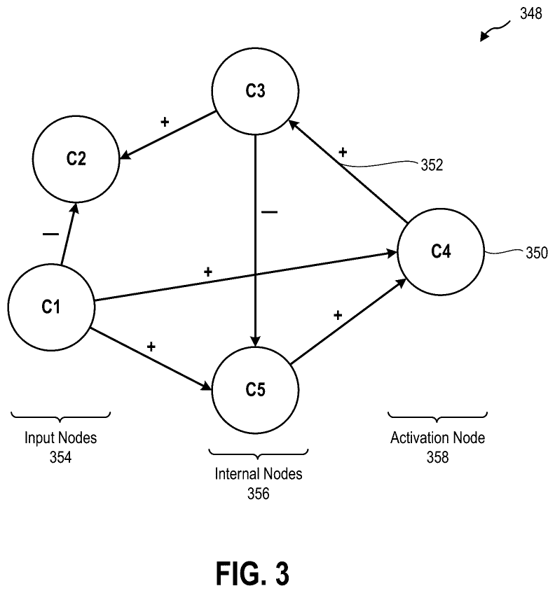

FIG. 3 is an embodiment of a decision engine, such as created by a large language model described in relation to FIG. 2 or as described in relation to the decision engine 116 of FIG. 1, including a fuzzy cognitive map 348. A fuzzy cognitive map 348 is a signed fuzzy directed graph that connects nodes 350 of the fuzzy cognitive map 348 via relations 352. In some embodiments, the nodes 350 represent concepts that are received as inputs to the neural network of the large language model creating the fuzzy cognitive map 348.

In some embodiments, each relation affects another node 350 and/or relation 352 in a negative way or a positive way. In some embodiments, each relation affects another node 350 and/or relation 352 in a negative way, a neutral way, or a positive way. For example, the fuzzy cognitive map 348 includes trivalent logic (−1.0, 0.0, +1.0) with which each relation 352 can affect other portions of the fuzzy cognitive map 348. In some embodiments, the fuzzy cognitive map 348 includes pentavalent logic (−1.0, −0.5, 0.0, +0.5, +1.0) with which each relation 352 can affect other portions of the fuzzy cognitive map 348. In some embodiments, the fuzzy cognitive map 348 includes substantially continuous logic in which each relation 352 associated nodes 350 with any scalar value from −1.0 to +1.0.

In some embodiments, the fuzzy cognitive map 348 includes input nodes 354, internal nodes 356, and activation nodes 358. In at least one embodiment, the activation node(s) 358 functions as an output node(s) of the fuzzy cognitive map 348 to provide an output of the fuzzy cognitive map 348. In some embodiments, the activation node(s) 358 and/or outputs of the fuzzy cognitive map 348 is correlated with a selected action from an action inventory (such as the action inventory 122 of FIG. 1).

In at least one example, the fuzzy cognitive map 348 is created by user inputs to a large language model, allowing the user to linguistically describe interactions with an interactive software application in an intuitive and natural way. The user can, therefore, create decision engines with one or more fuzzy cognitive maps 348 without a technical understanding of the mathematics and/or engineering required, further increasing the accessibility and efficiency of interactive software application testing and development with an autonomous agent according to some embodiments of the present disclosure.

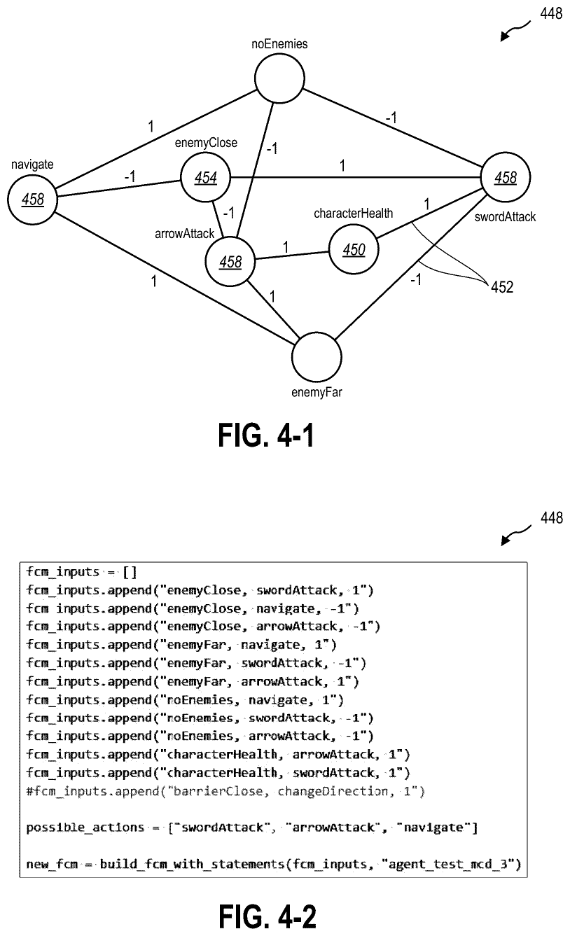

FIG. 4-1 is an example fuzzy cognitive map 448 created to navigate through and interact with objects, non-player characters, and environmental elements in a three-dimensional virtual environment. The embodiment of a fuzzy cognitive map 448 of FIG. 4-1 is created by linguistic inputs to a large language model (such as a neural network described in relation to FIGS. 1 and 2). The fuzzy cognitive map 448 includes a plurality of nodes 450 and relations 452 defined by the large language model based on causal effects interpreted from linguistic inputs into the large language model from a user. In the illustrated embodiment, an input node 454 is enemyClose, which has a positive relation 452 to the activation node 458 of swordAttack and a negative relation 452 to both navigate and arrowAttack activation nodes 458. In some embodiments, at least one activation node 458 is correlated to, includes, or is an available action of an action inventory.

FIG. 4-2 is an example set of possible decisions of the fuzzy cognitive map 448 described in relation to FIG. 4-1. The embodiment of code of FIG. 4-2 is code created by a large language model from linguistic inputs and linguistic objective inputs (such as those described in relation to FIG. 1) by a user. The user provides linguistic inputs such as “when an enemy is close, attack with a sword” and “when an enemy is far, attack with an arrow.” The large language model interprets the linguistic inputs as nodes and relations (e.g., nodes 450 and relations 452 of FIG. 4-1). In the illustrated embodiment, the action inventory is “possible actions”. The fuzzy cognitive map 448 can then receive inputs from a state detector (such as the state detector 114 of FIG. 1) into the input nodes 454 and select a “possible action” of an activation node 458 based at least partially on the relations 452 therebetween.

In some embodiments, the action inventory is created by a user training an imitation learning model (such as a neural network with supervised or semi-supervised training) of user inputs into a user input device. The emulator, in some embodiments, emulates the transmissions of the user input device to provide emulated inputs to the interactive software application. In some embodiments, the emulator receives a selected action (such as action 120 of FIG. 1) from the decision engine and emulates the user inputs associated with the action to create one or more emulated inputs (such as emulated inputs 128 of FIG. 1) to the interactive software application.

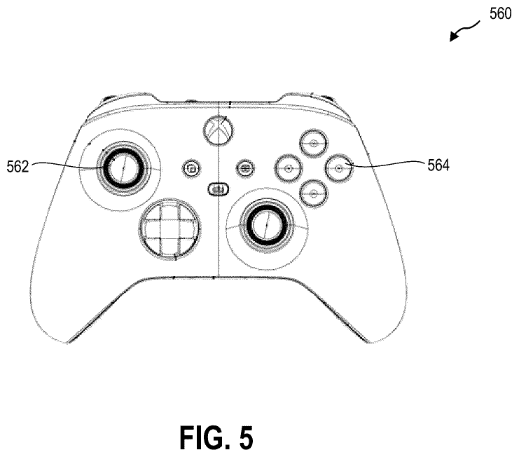

In some embodiments, for a decision engine, such as a decision engine including a fuzzy cognitive model, to select an action, the action inventory is created by training the emulator. FIG. 5 is a front view of an embodiment of a user input device 560 emulated by some embodiments of an emulator. In some embodiments, an emulator described herein is part of the system and/or agent described in relation to FIG. 1. The emulator receives user inputs from the user input device 560 and associates the user inputs to the user input device 560 as the user inputs to effectuate the associated action. For example, “navigate” is an action that is associated with a user input to the left thumbstick 562. The imitation model of the emulator then produces an emulated input of a measured direction and magnitude of a left thumbstick to the interactive software application when the “navigate” action is selected by the decision engine. In other embodiments, the action includes a plurality of user inputs, either sequential or simultaneous, that are emulated by the emulator to cause the action in the interactive software application.

For example, in a fighting video game, a series of directional inputs (down, diagonally down-toward the opponent, toward the opponent) from the left thumbstick 562 and a simultaneous input from the left thumbstick 562 and at least one face button 564 is associated with a fireball attack. In some embodiments, the fuzzy cognitive map and/or decision engine selects “fireball” as a selected action from a plurality of activation nodes. The emulator, in such an embodiment, receives the selected action and emulates the series of and simultaneous emulated inputs to the interactive software application.

In some embodiments, the user input device is a keyboard, computer mouse, video camera, depth camera, microphone, gamepad, touch-sensitive device, motion-sensing device, steering wheel, yoke, pedal, joystick, or other hardware peripheral capable of providing user inputs to the interactive software application. In some embodiments, a type, category, or specific user input device is defined by the interactive software application. For example, some interactive software applications include a list of compatible user input devices, such as a keyboard-and-mouse and a gamepad.

In some embodiments, the emulator is trained via supervised training from training datasets of user inputs with a first user input device while the emulator generates emulated inputs that emulate a second user input device. In at least one example, an action inventory includes “turn left”, and the emulator has an associated emulated input of turn left that includes a 50% left input of a steering wheel user input device. In some embodiments, the interactive software application running on the application computing device is compatible with gamepads and keyboards, and the emulator provides to the interactive software application a 50% left input of an emulated left thumbstick.

In some embodiments, the decision engine selects a selected action and transmits to the emulator a requested emulated input associated with the selected action. For example, the decision engine may select an activation node associated with the inputs to effectuate the action. In some embodiments, the emulator further simulates a human user by introducing one or more variations to the emulated input(s). In some embodiments, the emulator introduces a reaction delay to the emulated input. In some embodiments, a reaction delay is added before the emulated input is transmitted to the interactive software application to simulate a human reaction time. In some embodiments, the reaction delay is in a range having an upper value, a lower value, or upper and lower values including any of 100 milliseconds, 150 milliseconds, 200 milliseconds, 250 milliseconds, 300 milliseconds, 350 milliseconds, or any values therebetween. In some examples, the reaction delay is greater than 100 milliseconds. In some examples, the reaction delay is less than 350 milliseconds. In some examples, the reaction delay is between 100 milliseconds and 350 milliseconds. In some examples, the reaction delay is between 150 milliseconds and 300 milliseconds. In at least one example, the reaction delay is approximately 250 milliseconds.

In some embodiments, the emulator introduces one or more intra-input delays to better simulate a human user interacting with a physical user input device. For example, the emulator transmits emulated inputs faster than a human can physically press a button (such as the face buttons 564 described in relation to FIG. 5). In other examples, the interactive software application includes logic to ignore multiple inputs received within a period of time after a first input, such as logic to prevent cheating or to limit and/or prevent unintended inputs to the interactive software application. In some embodiments, the emulated input includes an intra-input delay between sequential inputs of an emulated input to better simulate a human user interacting with a physical user input device.

In some embodiments, the intra-input delay is in a range having an upper value, a lower value, or upper and lower values including any of 5 milliseconds 10 milliseconds, 15 milliseconds, 20 milliseconds, 25 milliseconds, 30 milliseconds, 35 milliseconds, or any values therebetween. In some examples, the reaction delay is greater than 5 milliseconds. In some examples, the reaction delay is less than 35 milliseconds. In some examples, the reaction delay is between 5 milliseconds and 35 milliseconds. In some examples, the reaction delay is between 10 milliseconds and 25 milliseconds. In at least one example, the reaction delay is approximately 15 milliseconds. For example, a 15 millisecond intra-input delay is approximately 1 frame in a 60 frame per second rendering of a virtual environment of the interactive software application.

In some embodiments, the emulator varies a delay duration (e.g., a length of a reaction delay and/or a length of an intra-input delay) to better simulate human variability. For example, an autonomous agent, according to the present disclosure, that is used to test an educational interactive software application includes variability in the reaction delay to better simulate a student's reaction time to the presented material in the interactive software application. In another example, an autonomous agent, according to the present disclosure, that is used to test a fighting video game interactive software application includes variability in the intra-input delay to better simulate the precision of human inputs and test an input buffer window of the video game interactive software application.

As described herein, the emulator and/or decision engine includes an action inventory (such as the action inventory 122 of FIG. 1) of selectable actions correlated with activation nodes and/or output nodes of the decision engine. In some embodiments, the decision engine receives input at input nodes from at least a state detector. In some embodiments, the state detector includes a machine vision model that detects and/or identifies shapes, patterns, objects, colors, textures, animations, characters, or other visual cues in the video information rendered by the interactive software application.

In some embodiments, the machine vision model includes a kernel-based edge detection model that can detect edges of objects or characters in the video information rendered by the interactive software application. In some embodiments, the machine vision model receives the video information from the interactive software application in real-time to allow the autonomous agent (such as any embodiment of an autonomous agent described herein) to “see” the interactive software application similar to how a human user would view the visual information on a display device.

In some embodiments, the kernel-based edge detection model calculates a magnitude and direction of change in a pixel value between a core pixel and a kernel of neighboring pixels (i.e., first-order neighboring pixels, second-order neighboring pixels, third-order neighboring pixels). In some embodiments, the kernel-based edge detection model calculates a difference in grayscale value between the core pixel and the surrounding neighboring pixels. In some embodiments, the kernel-based edge detection model includes applying a mask or filter, such as a Gaussian filter or derivative thereof, to the pixels of the frame of video information. For example, the Gaussian filter or derivative thereof acts on the grayscale value of the pixels. The intensity gradient of the grayscale value is subsequently calculated.

A difference in grayscale value between the core pixel and neighboring pixels greater than a threshold value indicates the presence of an edge in the video information. The edge(s) detected by the edge detection model allows the machine vision model to identify characters, objects, textures, etc., in the video information. In some embodiments, the characters, objects, textures, etc., are identified in a three-dimensional virtual environment, such as in a video game or other virtual space. In some embodiments, the characters, objects, textures, etc., are identified in a two-dimensional virtual environment, such as a user interface. In some embodiments, the video information includes both a three-dimensional virtual environment and a two-dimensional virtual environment, such as a user interface overlaid on a rendering of a three-dimensional virtual environment.

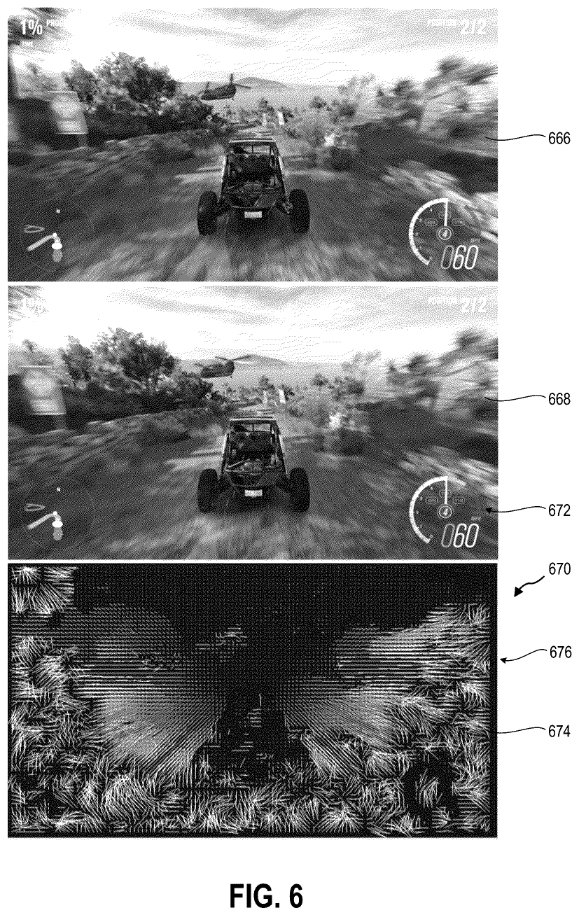

In some embodiments, other edge detection or object detection models are used. In some embodiments, the machine vision model can compare changes between pixels or objects from a first frame of the video information to a second frame of the video information. In some embodiments, the machine vision model receives a first frame and holds the first frame in a buffer while receiving the second frame. In some embodiments, the machine vision model compares the pixels and/or objects of the first frame to the pixels and/or objects of the second frame to determine a motion vector field between the first frame 666 and the second frame 668, such as illustrated in the embodiment of FIG. 6. In some embodiments, the motion vector field can assist the machine vision model in detecting objects, characters, and the movement thereof to identify animations or other events in the video information. In some embodiments, the motion vector field can assist the machine vision model in differentiating between a user interface 672 and a rendering of a three-dimensional virtual environment on which the user interface 672 is overlaid. In some embodiments, the motion vector field 670 reflects a region of relatively low-magnitude vectors 674 corresponding to the user interface 672 compared to regions of relatively high-magnitude vectors 676 of the three-dimensional virtual environment.

In some embodiments, the detected objects, textures, characters, animations, events, and other visual cues are transmitted to the decision model as inputs to the decision engine, such as input nodes of a fuzzy cognitive map as described in relation to FIG. 3 through FIG. 4-2.

In some embodiments, the interactive software application provides audio information. The state detector, in some embodiments, receives the audio information and detects and/or identifies a sound effect, a voice, music, or other audio cues in the audio information. The state detector can compare a waveform of the sound effect sound effect, a voice, music, or other audio cues to a reference waveform.

In some embodiments, a reference waveform is obtained from an application module that includes visual cues and/or audio cues associated with the interactive software application. The application module informs the state detector of the possible visual cues and/or audio cues in the video information and/or audio information generated by the interactive software application.

In some embodiments, the state detector uses one or more libraries from one or more interactive software applications to train a model that recognize objects, scenes, and sounds. In some embodiments, after training the model, the model functions without reference to the libraries. In some embodiments, a general model is used across different interactive software applications, such as interactive software applications within a particular genre.

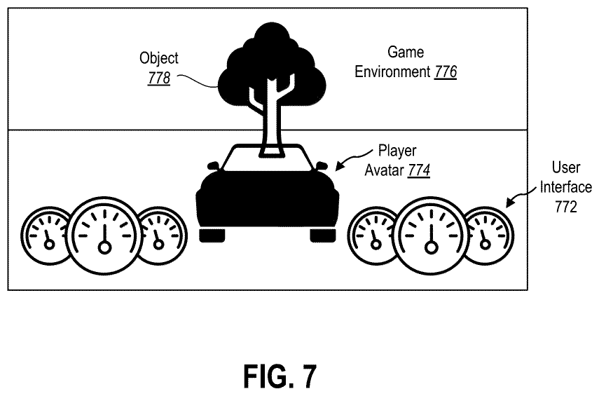

FIG. 7 is an embodiment of a frame of video information received from the interactive software application that may be used for identifying events within the user's gameplay. In FIG. 7, a frame of video information includes an object 778 (e.g., a tree) positioned in the virtual environment 776 with the player avatar 774, in this case a car. Other objects in the frame include the user interface 772 which may be independent of the three-dimensional virtual environment 776. The machine vision identifies one or more of the position, size, and shape of the tree object 778 relative to the player avatar 774 to determine relative position of the tree object 778 and the avatar 774 in the virtual environment 776. By evaluating the relative position of the object 778 and the avatar 774 in one frame or a sequence of frames (adjacent frames at the native framerate or non-adjacent key frames), the machine vision model identifies a crash event between the car and the tree.

In some embodiments, the video information of the interactive software application provided by the application computing device running the interactive software application is associated with software state data. Software state data includes any information that may allow a second electronic device to recreate a given software state. For example, the software state data of a software instance running on an application computing device may be provided to a second electronic device, such as a computing device running the autonomous agent and/or the state detector, which may render a duplicate of the first software instance based on the software state data. In some embodiments, software state data includes virtual object or avatar positions, movement, player character statistics or characteristics, player character inventory, player character status, ability cooldown status, non-player character status, user interface configurations, or any other information about the software state.

Because the video information can be associated with the software state data, object identifications (IDs) may be associated with the objects detected in the video information, allowing higher reliability in the object detection. Additionally, the software state data may include object IDs, which can be compared to the detected objects to refine a machine vision model and/or improve the object detection of the machine vision model. In some embodiments, the software state data received from the interactive software application is independent of the video and/or audio information. In at least one embodiment, no video information and/or audio information is received from the interactive software application, and state detector interprets the software state data. For example, interpretation of software state data by the state detector allows some embodiments of an autonomous agent according to the present disclosure to determine a state and provide inputs to the decision model before visual design of the interactive software application is complete. Therefore, testing of the interactive software application can begin with an autonomous agent prior to being possible by a human user.

In some embodiments, as described herein, machine vision and/or object detection can measure relative motion of edges to determine the position of virtual objects. For example, a detected object that does not change position within the frames across a plurality of frames of the video information while the avatar moves and/or the user's perspective relative to the virtual environment moves may be an element of the user interface 772. In other examples, a detected object that increases in size differently than the other objects in the virtual environment may be moving relative to the virtual environment. In the illustrated embodiment in FIG. 7, a crash event is identified by a change in the user interface 772 depicting the speedometer rapidly and/or suddenly decreasing in value. For example, a rapid change in the user interface 772 reflecting a change in speed of the car avatar 774 from 150 kilometers per hour (kph) to 0 kph in under 1.0 seconds is identified as a crash.

A virtual object, as used herein, may include any object or element rendered or presented by the application computing device in the process of running the interactive software application. For example, a virtual object may be an element of the user interface 772. In some examples, a virtual object may be a player avatar 774. In some examples, the virtual object may be wall, floor, or other geometry of the virtual environment 776 such as a tree object 778. In some examples, the virtual object may be an interactive or movable object within the virtual environment, such as a door, crate, or power-up.

In some embodiments, the machine vision model can identify objects in the virtual environment 776 without explicit training to identify the object. For example, a machine vision system that includes ML may learn to identify tree objects 778 within the virtual environment 776, even if the particular model of tree object 778 has not been explicitly taught to the machine vision system. In at least one example, systems and methods according to the present disclosure may be portable between video information from a variety of interactive software applications where different models for common objects, such as the tree object 778, are used. By training the ML model, the machine vision may be able to recognize and detect a tree object 778 in the video information. In some examples, elements of the virtual environment are procedurally generated. A series of procedurally generated tree objects 778 may include common elements but be distinct models from one another, as rendered in the video information. Therefore, an explicitly provided model would be inapplicable to procedurally generated tree objects 778.

In some embodiments, the machine vision system obtains and/or invokes an application module that is associated with the interactive software application that is the source of the video information. In some embodiments, systems and methods, according to the present disclosure, access an application module that is associated with the interactive software application that is the source of the video information. In some embodiments, the application module includes visual cues and/or audio cues generated by the machine vision model based on the interactive software application, may include predetermined or user-defined visual cues and/or audio cues, or combinations of both.

Art styles can vary considerably between interactive software applications. Even a machine vision model that has been trained on video information from a plurality of interactive software applications to detect tree objects 778 may fail when presented with a new art style. For example, while both FORNITE and CALL OF DUTY are competitive first-person shooter games, the appearance of objects is very different between the interactive software applications. Specifically, tree objects 778 and other virtual objects of the virtual environment 776 appear very different between the two interactive software applications.

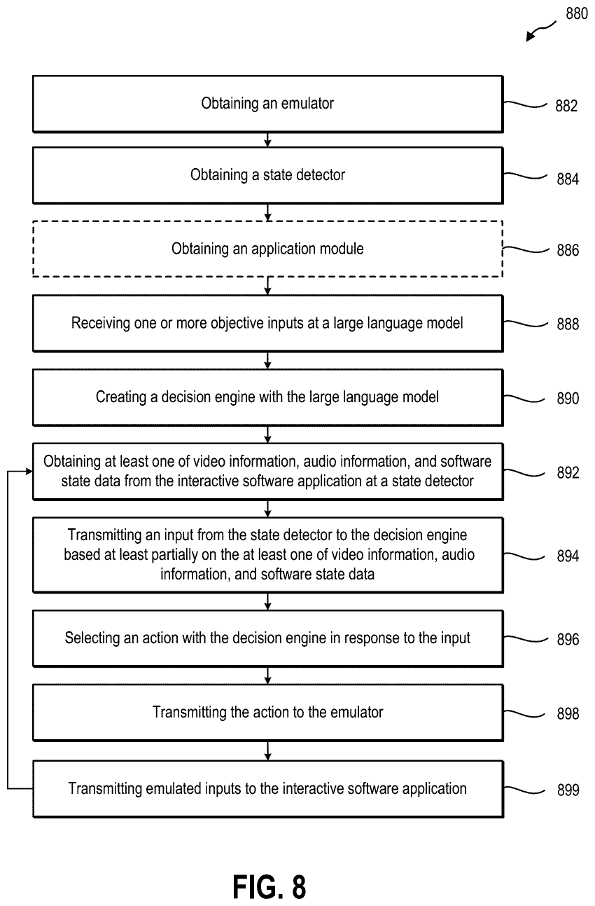

FIG. 8 is a flowchart illustrating an embodiment of a method 880 of creating an autonomous agent for interacting with an interactive software application. In some embodiments, the method 880 includes obtaining an emulator at 882 and obtaining a state detector at 884. As described herein, such as in relation to FIG. 5, obtaining an emulator, in some embodiments, includes training an imitation learning model of the emulator to replicate user input device inputs to a user input device as emulated inputs. In some embodiments, the training includes training instances and/or datasets that include user input device inputs associated with actions of the interactive software application. In some embodiments, the actions are included in an action inventory of possible actions in the interactive software application. The emulator and/or imitation learning model is able to produce an emulated input based on a requested action of the action inventory.

As described herein, such as in relation to FIGS. 6 and 7, obtaining a state detector, in some embodiments, includes training or obtaining a machine vision model to detect and/or identify visual cues and/or audio cues in video information and/or audio information. In some embodiments, the state detector is configured to interpret and/or detect software state data to determine the presence of and/or changes to objects, textures, characters, animations, events, and combinations thereof in the software state data.

In some embodiments, the state detector, optionally, includes or accesses an application module with information relating to visual cues, audio cues, objects, textures, characters, animations, events, and combinations thereof associated with the interactive software application at 886. In some embodiments, the application module is obtained from an application computing device executing the interactive software application. In some embodiments, the application module is obtained by the state detector and/or the autonomous agent from a remote storage device (e.g., cloud storage device). In some embodiments, the application module is stored and accessed locally to the autonomous agent, such as on an agent computing device executing at least a portion of the autonomous agent. In at least one embodiment, the application module includes both an action inventory associated with the interactive software application and information related to visual cues, audio cues, objects, textures, characters, animations, events, and combinations thereof associated with the interactive software application.

The method 880 further includes, in some embodiments, receiving one or more objective inputs at a large language model at 888. In some embodiments, the objective inputs are linguistic objective inputs. The linguistic objective inputs are interpreted by the large language model, such as the embodiment of a large language model described in relation to FIG. 1 and FIG. 2, to associate state inputs with available actions. In some embodiments, the linguistic objective inputs include references to visual cues, audio cues, objects, textures, characters, animations, events, and combinations thereof associated with the interactive software application. In some embodiments, the large language model associates the linguistic objective inputs with the visual cues, audio cues, objects, textures, characters, animations, events, and combinations thereof associated with the interactive software application. In some embodiments, the linguistic objective inputs include references to one or more actions from the action inventory associated with the interactive software application. In some embodiments, the large language model associates the linguistic objective inputs with one or more actions from the action inventory associated with the interactive software application.

In some embodiments, the method 880 includes creating a decision engine with the large language model at 890. In some embodiments, the large language model receives the objective inputs and interprets the objective inputs as relations between state inputs and actions to accomplish one or more objectives according to the objective inputs. For example, the state inputs include one or more of visual cues, audio cues, objects, textures, characters, animations, events, and combinations thereof associated with the interactive software application. In some examples, actions are selected from one or more actions of an action inventory associated with the interactive software application.

In some embodiments, the large language model creates a fuzzy cognitive map, such as the fuzzy cognitive maps describe in relation to FIG. 3 through FIG. 4-2. In some embodiments, the state inputs are input nodes of the fuzzy cognitive map(s) and the actions are output nodes and/or activation nodes of the fuzzy cognitive map(s). The relations therebetween (and internal nodes) of the fuzzy cognitive map(s) are determined and created by the large language model.

In some embodiments, each relation affects another node and/or relation in a negative way, a neutral way, or a positive way. For example, the fuzzy cognitive map includes trivalent logic (−1.0, 0.0, +1.0) with which each relation can affect other portions of the fuzzy cognitive map. In some embodiments, the fuzzy cognitive map includes pentavalent logic (−1.0, −0.5, 0.0, +0.5, +1.0) with which each relation can affect other portions of the fuzzy cognitive map. In some embodiments, the fuzzy cognitive map includes substantially continuous logic in which each relation associated nodes with any scalar value from −1.0 to +1.0.

The method 880, in some embodiments, further includes obtaining at least one of video information, audio information, and software state data from the interactive software application at a state detector at 892. As described in relation to FIG. 6 and FIG. 7, the state detector detects at least one of visual cues, audio cues, objects, textures, characters, animations, events, and combinations thereof (state information) from the at least one of video information, audio information, and software state data from the interactive software application, and the method 880 includes transmitting a state input from the state detector to the decision engine based at least partially on the at least one of video information, audio information, and software state data at 894.

In some embodiments, the state input is received at the decision engine. The method includes selecting an action with the decision engine in response to the state input at 896. In some embodiments, selecting an action with the decision engine includes determining an activation node and/or output node of the fuzzy cognitive map based on relations between the input nodes and the activation node and/or output node and the state input(s) at the input nodes.

In some embodiments, the method 880 includes transmitting the action to the emulator at 898. In some embodiments, transmitting the action includes transmitting a series of requested emulated inputs to the emulator. In some embodiments, transmitting the action includes transmitting an action from an action inventory to the emulator. The method 880 further includes transmitting emulated inputs to the interactive software application at 899. In some embodiments, the emulator interprets the action with an imitation learning model to generate one or more emulated inputs. In some embodiments, the emulator interprets the requested emulated inputs to generate one or more emulated inputs based on an emulated user input device. In some embodiments, the emulated inputs are based on a user input device, such as a keyboard, computer mouse, video camera, depth camera, microphone, gamepad, touch-sensitive device, motion-sensing device, steering wheel, yoke, pedal, joystick, or other hardware peripheral capable of providing user inputs to the interactive software application. In some embodiments, a type, category, or specific user input device is defined by the interactive software application. For example, some interactive software applications include a list of compatible user input devices, such as a keyboard-and-mouse and a gamepad.

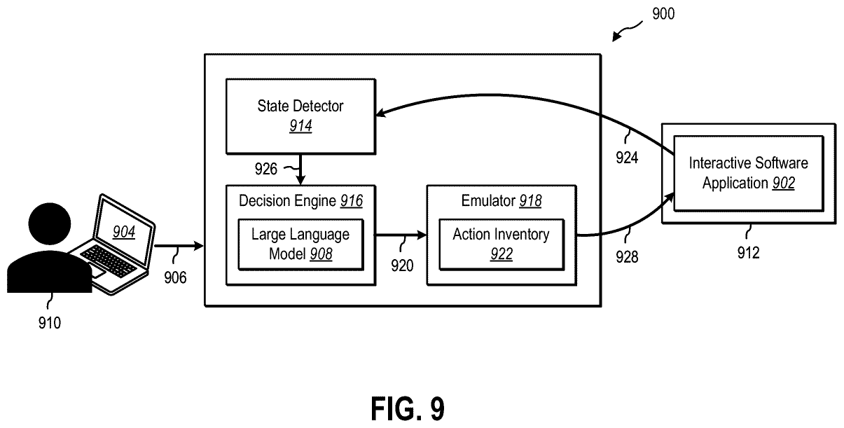

As described herein, some embodiments of an autonomous agent include a large language model that is or is part of the decision engine. FIG. 9 is an embodiment of a system including an autonomous agent 900 with a decision engine 916 including a large language model 908. In such embodiments, the large language model 908 receives objective inputs 906 from a client device 904. In some embodiments, a user 910 of the client device 904 provides the objective inputs 906. The autonomous agent 900 uses the objective inputs 906 to direct the decisions made by and emulator inputs provided by the autonomous agent 900 to the interactive software application 902.

In some embodiments, the interactive software application 902 is executed on an application computing device 912 that runs the interactive software application 902 remotely from the autonomous agent 900. In some embodiments, the application computing device 912 is a personal computing device, such as a laptop computer, a desktop computer, a hybrid computing device, a tablet computing device, a smartphone computing device, a video game console computing device, or other computing device. In some embodiments, the application computing device 912 is a server computing device that executes the interactive software application 902 remotely from the autonomous agent 900. In some embodiments, the application computing device 912 is a client device 904. For example, the application computing device 912 is a desktop computer client device 904, the user 910 interacts with the desktop computer client device 904, and the autonomous agent 900 runs remotely to the client device 904 and the application computing device 912. In at least one example, the application computing device 912 is a video game console, the client device 904 is a personal computing device, and the autonomous agent 900 is executed on a server computer (or plurality of server computers) with which the client device 904 and application computing device 912 communicate via network communications.

In some embodiments, the application computing device 912 executes the autonomous agent 900. For example, the application computing device 912 is a server computing device that runs both the interactive software application 902 and the autonomous agent 900. In another example, the application computing device 912 is a desktop computing device that runs both the interactive software application 902 and the autonomous agent 900. In some embodiments, the application computing device 912 executes at least one component of the autonomous agent 900. For example, the application computing device 912 executes at least one of a state detector 914, a decision engine 916, an emulator 918, or a large language model 908. In a particular example, a decision engine 916 transmits an action 920 selected from an action inventory 922 of an emulator 918 that runs natively on the application computing device 912. The emulator 918 then provides emulated inputs to the interactive software application 902.

In some embodiments, the state detector 914 is executed locally (e.g., on the same computing device) as the interactive software application 902. For example, a state detector 914 performs object and/or event detection on video information from the interactive software application 902 rendered on the application computing device 912 and provides the object and/or event detection information to the decision engine 916 being executed remotely (e.g., on a server computing device).

The interactive software application 902 is any category or genre of interactive software with which a user 910 and/or agent 900 interacts in real-time during usage of the interactive software application 902. In some embodiments, the interactive software application 902 is an electronic game. In some embodiments, the interactive software application 902 is design software, such as computer assisted design software. In some embodiments, the interactive software application 902 is office productivity software, such as a word processor. In some embodiments, the interactive software application 902 is an internet or network browser. In some embodiments, the interactive software application 902 is educational software.

In at least one example, the application computing device 912 and the client device 904 are the same device. In some embodiments, the application computing device 912, an agent computing device (i.e., a computing device executing at least a portion of the autonomous agent 900), and the client device 904 are the same device. In some embodiments, the agent computing device and the client device 904 are the same device. In some embodiments, the agent computing device and the application computing device 912 are the same device.

As described herein, the autonomous agent 900 replicates a human user of the interactive software application 902 by use of components that replicate one or more of how a human user receives video and/or audio information 924 from the interactive software application 902, how a human user interprets state information 926 in the video and/or audio information 924, how a human user reacts to the objects and/or events toward an objective (e.g., based at least partially on the objective input 906), how a human user selects an action 920 in response to the state information 926, and how a human user provides a user input device input (e.g., emulated input 928) to the interactive software application 902 to effect the action 920 in the interactive software application 902. By replicating a human user's interaction with the interactive software application 902, the autonomous agent 900, in some embodiments, allows for more accurate testing of the interactive software application 902 without direct invention from a human user and/or allows for more accurate simulation of a teammate, an opponent, or another user interacting with the interactive software application 902 in real-time with a human user.

In some embodiments, the components of the autonomous agent 900 use different types of machine learning models or other logic models to efficiently simulate a human user. The state detector 914 is or includes, in some embodiments, a machine vision model to identify virtual objects, textures, characters, animations, events, sounds, or other details of the video and/or audio information. The emulator 918 is or includes, in some embodiments, an imitation learning model, that allows the emulator to associate emulated inputs 928 with actions 920.

The decision engine 916 is or includes, in some embodiments, a large language model 908. In some embodiments, the decision engine is or includes a large language model 908 that receives the state information 926 from the state detector 914 and selects an action 920 from an action inventory 922 toward an objective based on the objective input(s) 906.

In some embodiments, a decision engine 916 that includes or is a large language model 908 is versatile and able to interpret a broader range of state information 926 (e.g., state inputs). In some embodiments, a large language model interpreting state information 926 and providing actions 920 is computationally resource intensive. In some embodiments, decision speed and efficiency are improved by a dedicated system-on-chip executing the large language model 908.

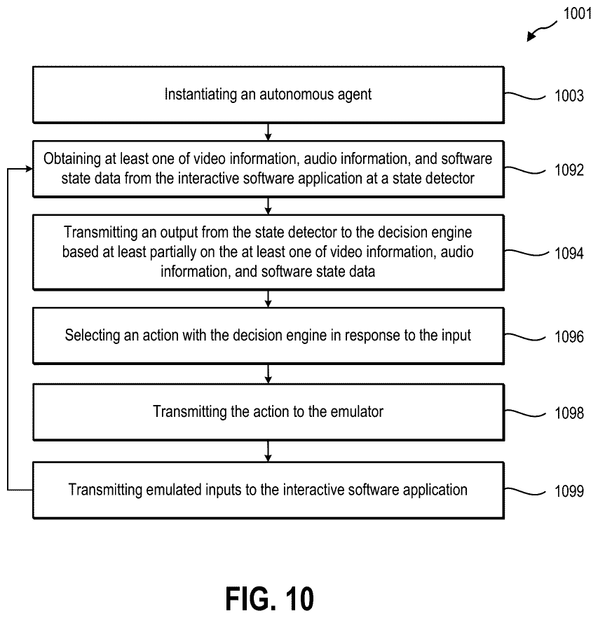

FIG. 10 is a flowchart illustrating a method 1001 of using an autonomous agent to interact with an interactive software application. In some embodiments, the method 1001 includes instantiating an autonomous agent at 1003. In some embodiments, the autonomous agent is instantiated on the same computing device that executes the interactive software application.

The method 1001, in some embodiments, further includes obtaining at least one of video information, audio information, and software state data from the interactive software application at a state detector at 1092. As described in relation to FIG. 6 and FIG. 7, the state detector detects at least one of visual cues, audio cues, objects, textures, characters, animations, events, and combinations thereof (state information) from the at least one of video information, audio information, and software state data from the interactive software application, and the method 1001 includes transmitting a state input from the state detector to the decision engine based at least partially on the at least one of video information, audio information, and software state data at 1094.

In some embodiments, the state input is received at the decision engine. The method 1001 includes selecting an action with the decision engine in response to the state input at 1096. In some embodiments, selecting an action with the decision engine includes determining an activation node and/or output node of the fuzzy cognitive map based on relations between the input nodes and the activation node and/or output node and the state input(s) at the input nodes.

In some embodiments, the method 1001 includes transmitting the action to the emulator at 1098. In some embodiments, transmitting the action includes transmitting a series of requested emulated inputs to the emulator. In some embodiments, transmitting the action includes transmitting an action from an action inventory to the emulator. The method 1001 further includes transmitting emulated inputs to the interactive software application at 1099. In some embodiments, the emulator interprets the action with an imitation learning model to generate one or more emulated inputs. In some embodiments, the emulator interprets the requested emulated inputs to generate one or more emulated inputs based on an emulated user input device. In some embodiments, the emulated inputs are based on a user input device, such as a keyboard, computer mouse, video camera, depth camera, microphone, gamepad, touch-sensitive device, motion-sensing device, steering wheel, yoke, pedal, joystick, or other hardware peripheral capable of providing user inputs to the interactive software application. In some embodiments, a type, category, or specific user input device is defined by the interactive software application. For example, some interactive software applications include a list of compatible user input devices, such as a keyboard-and-mouse and a gamepad.

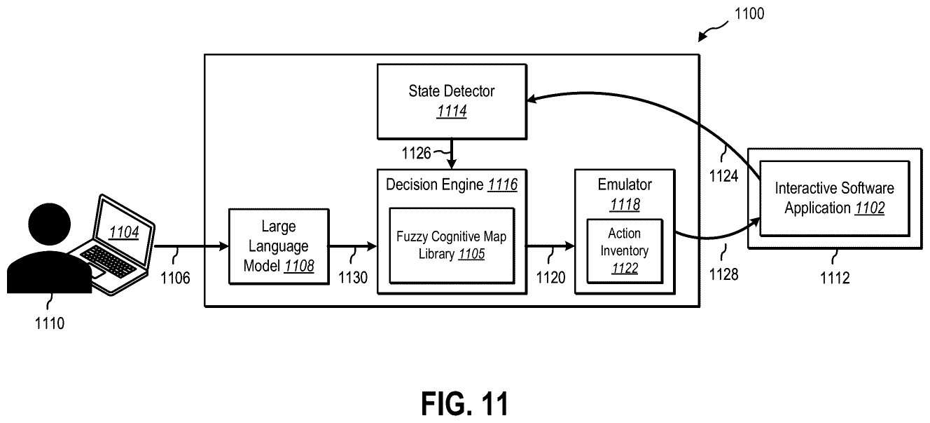

In some embodiments, the decision engine includes a plurality of fuzzy cognitive maps that allow the decision engine to be customized based on the state information. FIG. 11 is an embodiment of an autonomous agent with a fuzzy cognitive map library 1105 in the decision engine 1116. In at least one example, each fuzzy cognitive map is lightweight and less computationally resource intensive than a large language model 1108, allowing the decision engine 1116 to react to the state information 1126 and select an action 1120 more quickly than a large language model 1108. In some embodiments, a plurality of fuzzy cognitive maps in the fuzzy cognitive map library 1105 allows the decision engine 1116 to limit decisions and action selection based on context from the state information 1126, further reducing computational requirements and improving speed and efficiency.

In some embodiments, a client device 1104 provides objective inputs 1106 to a large language model 1108 of the autonomous agent 1100. In some embodiments, a user 1110 of the client device 1104 provides the objective inputs 1106. The autonomous agent 1100 uses the objective inputs 1106 to direct the decisions made by and emulator inputs provided by the autonomous agent 1100 to the interactive software application 1102.

In some embodiments, the interactive software application 1102 is executed on an application computing device 1112 that runs the interactive software application 1102 remotely from the autonomous agent 1100. In some embodiments, the application computing device 1112 is a personal computing device, such as a laptop computer, a desktop computer, a hybrid computing device, a tablet computing device, a smartphone computing device, a video game console computing device, or other computing device. In some embodiments, the application computing device 1112 is a server computing device that executes the interactive software application 1102 remotely from the autonomous agent 1100. In some embodiments, the application computing device 1112 is a client device 1104. For example, the application computing device 1112 is a desktop computer client device 1104, the user 1110 interacts with the desktop computer client device 1104, and the autonomous agent 1100 runs remotely to the client device 1104 and the application computing device 1112. In at least one example, the application computing device 1112 is a video game console, the client device 1104 is a personal computing device, and the autonomous agent 1100 is executed on a server computer (or plurality of server computers) with which the client device 1104 and application computing device 1112 communicate via network communications.

In some embodiments, the application computing device 1112 executes the autonomous agent 1100. For example, the application computing device 1112 is a server computing device that runs both the interactive software application 1102 and the autonomous agent 1100. In another example, the application computing device 1112 is a desktop computing device that runs both the interactive software application 1102 and the autonomous agent 1100. In some embodiments, the application computing device 1112 executes at least one component of the autonomous agent 1100. For example, the application computing device 1112 executes at least one of a state detector 1114, a decision engine 1116, an emulator 1118, or a large language model 1108. In a particular example, a decision engine 1116 transmits an action 1120 selected from an action inventory 1122 to an emulator 1118 that runs natively on the application computing device 1112. The emulator 1118 then provides emulated inputs to the interactive software application 1102.

In some embodiments, the state detector 1114 is executed locally (e.g., on the same computing device) as the interactive software application 1102. For example, a state detector 1114 performs object and/or event detection on video information from the interactive software application 1102 rendered on the application computing device 1112 and provides the object and/or event detection information to the decision engine 1116 being executed remotely (e.g., on a server computing device).

The interactive software application 1102 is any category or genre of interactive software with which a user 1110 and/or agent 1100 interacts in real-time during usage of the interactive software application 1102. In some embodiments, the interactive software application 1102 is an electronic game. In some embodiments, the interactive software application 1102 is design software, such as computer assisted design software. In some embodiments, the interactive software application 1102 is office productivity software, such as a word processor. In some embodiments, the interactive software application 1102 is an internet or network browser. In some embodiments, the interactive software application 1102 is educational software.

In at least one example, the application computing device 1112 and the client device 1104 are the same device. In some embodiments, the application computing device 1112, an agent computing device (i.e., a computing device executing at least a portion of the autonomous agent 1100), and the client device 1104 are the same device. In some embodiments, the agent computing device and the client device 1104 are the same device. In some embodiments, the agent computing device and the application computing device 1112 are the same device.

As described herein, the autonomous agent 1100 replicates a human user of the interactive software application 1102 by use of components that replicate one or more of how a human user receives video and/or audio information 1124 from the interactive software application 1102, how a human user interprets state information 1126 in the video and/or audio information 1124, how a human user reacts to the objects and/or events toward an objective 1130 (e.g., based at least partially on the objective input 1106), how a human user selects an action 1120 in response to the state information 1126, and how a human user provides a user input device input (e.g., emulated input 1128) to the interactive software application 1102 to effect the action 1120 in the interactive software application 1102. By replicating a human user's interaction with the interactive software application 102, the autonomous agent 1100, in some embodiments, allows for more accurate testing of the interactive software application 1102 without direct invention from a human user and/or allows for more accurate simulation of a teammate, an opponent, or another user interacting with the interactive software application 1102 in real-time with a human user.

In some embodiments, the components of the autonomous agent 1100 use different types of machine learning models or other logic models to efficiently simulate a human user. The state detector 1114 is or includes, in some embodiments, a machine vision neural network to identify virtual objects, textures, characters, animations, events, sounds, or other details of the video and/or audio information as will be described in more detail herein. The emulator 1118 is or includes, in some embodiments, an imitation learning model, that allows the emulator to associate emulated inputs 1128 with actions 1120.

In some embodiments, the decision engine 1116 selects a fuzzy cognitive map from a fuzzy cognitive map library 1105 before selecting an action 1120. In some embodiments, the decision engine 1116 selects a fuzzy cognitive map from a fuzzy cognitive map library 1105 in response to state information 1126 received from the state detector 1114. For example, the decision engine 1116 selects the fuzzy cognitive map in response to at least one of visual cues, audio cues, objects, textures, characters, animations, events, and combinations thereof associated with the interactive software application.

In some embodiments, the visual cues, audio cues, objects, textures, characters, animations, events, and combinations thereof associated with the interactive software application provide the decision engine 1116 with context to limit size of the fuzzy cognitive map and improve decision accuracy, speed, and efficiency. In some embodiments, for any given state of the interactive software application, there are only a subset of possible objects and/or events to detect, a subset of decisions to be made, a subset of available actions. By limiting the quantity of nodes and quantity of relations therebetween the decision engine 1116 can provide actions 1120 in response to state information 1126 (state inputs to the fuzzy cognitive map) faster and more efficiently.

The present disclosure relates to systems and methods for creating autonomous agents for testing interactive software applications according to at least the examples provided in the clauses below:

Clause 1. A method of creating an autonomous agent for interacting with an interactive software application, the method comprising: obtaining an emulator; obtaining a state detector; receiving one or more objective inputs at a large language model; creating a decision engine with the large language model and the objective inputs; obtaining at least one of video information, audio information, and software state data from the interactive software application at the state detector; transmitting state information from the state detector to the decision engine based at least partially on the at least one of video information, audio information, and software state data; selecting an action with the decision engine in response to the state information; transmitting the action to the emulator; and transmitting at least one emulated input of the action to the interactive software application.

Clause 2. The method of clause 1, further comprising obtaining an application module including one or more of visual cues, audio cues, objects, textures, characters, animations, and events of the interactive software applications.

Clause 3. The method of clause 2, wherein the application module includes at least one action of the interactive software application.

Clause 4. The method of any preceding clause, wherein the objective input is a linguistic objective input.

Clause 5. The method of any preceding clause, wherein the emulator includes an imitation learning model.

Clause 6. The method of any preceding clause, wherein the state detector includes a machine vision model.

Clause 7. The method of clause 6, wherein the machine vision model compares a first frame of the video information to a second frame of the video information.

Clause 8. The method of any preceding clause, wherein creating a decision engine with the large language model and the objective inputs includes the large language model creating a fuzzy cognitive map.

Clause 9. The method of any preceding clause, wherein creating a decision engine with the large language model and the objective inputs includes the large language model creating a fuzzy cognitive map library including a plurality of fuzzy cognitive maps.

Clause 10. A system for interacting with an interactive software application, the system comprising: an agent computing device including: a decision engine configured to select an action in response to state information; a state detector that provides state information to the decision engine, wherein the state information is based at least partially on video information, audio information, and software state data from the interactive software application; and an emulator in communication with the decision engine, wherein the emulator generates emulated inputs in response to the action selected by the decision engine.

Clause 11. The system of clause 10, further comprising a large language model, wherein the large language model is configured to receive linguistic objective inputs and provide objectives to the decision engine.

Clause 12. The system of clause 11, wherein the agent computing device further includes the large language model.

Clause 13. The system of any of clauses 10-12, wherein the decision engine includes a fuzzy cognitive map with input nodes that receive the state information and activation nodes correlated to actions.

Clause 14. The system of clause 13, wherein the decision engine includes a fuzzy cognitive map library including a plurality of fuzzy cognitive maps.

Clause 15. The system of any of clauses 10-14, wherein the emulator includes an imitation learning model.

Clause 16. The system of any of clauses 10-15, further comprising an application module including one or more of visual cues, audio cues, objects, textures, characters, animations, and events of the interactive software applications and at least one action of the interactive software application.

Clause 17. A method of interacting with an interactive software application instantiating an autonomous agent; obtaining at least one of video information, audio information, and software state data from the interactive software application at a state detector of the autonomous agent; transmitting state information from the state detector to a decision engine of the autonomous agent based at least partially on the at least one of video information, audio information, and software state data; selecting an action with the decision engine in response to the state information; transmitting the action to an emulator of the autonomous agent; and transmitting at least one emulated input of the action to the interactive software application.

Clause 18. The method of clause 17, wherein transmitting at least one emulated input includes a reaction delay before the at least one emulated input.

Clause 19. The method of clause 17, transmitting at least one emulated input includes transmitting a series of emulated inputs or simultaneous emulated inputs.

Clause 20. The method of clause 19, wherein transmitting a series of emulated inputs includes an intra-input delay in the series of emulated inputs.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of creating an autonomous agent for interacting with an interactive software application, the method comprising:
obtaining an emulator;
obtaining a state detector;
receiving one or more objective inputs at a large language model;
creating a decision engine with the large language model and the objective inputs;
obtaining at least one of video information, audio information, and software state data from the interactive software application at the state detector;
transmitting state information from the state detector to the decision engine based at least partially on the at least one of video information, audio information, and software state data;
selecting an action with the decision engine in response to the state information;
transmitting the action to the emulator; and
transmitting at least one emulated input of the action to the interactive software application.

2. The method of claim 1, further comprising obtaining an application module including one or more of visual cues, audio cues, objects, textures, characters, animations, and events of the interactive software applications.

3. The method of claim 2, wherein the application module includes at least one action of the interactive software application.

4. The method of claim 1, wherein the objective input is a linguistic objective input.

5. The method of claim 1, wherein the emulator includes an imitation learning model.

6. The method of claim 1, wherein the state detector includes a machine vision model.

7. The method of claim 6, wherein the machine vision model compares a first frame of the video information to a second frame of the video information.

8. The method of claim 1, wherein creating a decision engine with the large language model and the objective inputs includes the large language model creating a fuzzy cognitive map.

9. The method of claim 1, wherein creating a decision engine with the large language model and the objective inputs includes the large language model creating a fuzzy cognitive map library including a plurality of fuzzy cognitive maps.

10. A system for interacting with an interactive software application, the system comprising:
an agent computing device including:
a decision engine configured to select an action in response to state information;
a state detector that provides state information to the decision engine, wherein the state information is based at least partially on video information, audio information, and software state data from the interactive software application; and
an emulator in communication with the decision engine, wherein the emulator generates emulated inputs in response to the action selected by the decision engine.

11. The system of claim 10, further comprising a large language model, wherein the large language model is configured to receive linguistic objective inputs and provide objectives to the decision engine.

12. The system of claim 11, wherein the agent computing device further includes the large language model.

13. The system of claim 10, wherein the decision engine includes a fuzzy cognitive map with input nodes that receive the state information and activation nodes correlated to actions.

14. The system of claim 13, wherein the decision engine includes a fuzzy cognitive map library including a plurality of fuzzy cognitive maps.

15. The system of claim 10, wherein the emulator includes an imitation learning model.

16. The system of claim 10, further comprising an application module including one or more of visual cues, audio cues, objects, textures, characters, animations, and events of the interactive software applications and at least one action of the interactive software application.

17. A method of interacting with an interactive software application instantiating an autonomous agent;
obtaining at least one of video information, audio information, and software state data from the interactive software application at a state detector of the autonomous agent;
transmitting state information from the state detector to a decision engine of the autonomous agent based at least partially on the at least one of video information, audio information, and software state data;
selecting an action with the decision engine in response to the state information;
transmitting the action to an emulator of the autonomous agent; and
transmitting at least one emulated input of the action to the interactive software application.

18. The method of claim 17, wherein transmitting at least one emulated input includes a reaction delay before the at least one emulated input.

19. The method of claim 17, transmitting at least one emulated input includes transmitting a series of emulated inputs or simultaneous emulated inputs.

20. The method of claim 19, wherein transmitting a series of emulated inputs includes an intra-input delay in the series of emulated inputs.
